(19) United States
(12) Patent Application Publication
(10) Pub. No.: US 2011/0188967 A1
(43) Pub. Date: Aug. 4, 2011

(54) Magnesium Nut Manufacturing Method and Magnesium Nut Member Produced Thereby

(76) Inventor: Kuo-Chen Hung, Kaohsiung County (TW)

(21) Appl. No.: 12/945,116

(22) Filed: Nov. 12, 2010

Related U.S. Application Data
(63) Continuation-in-part of application No. 12/783,703, filed on May 20, 2010.

(30) Foreign Application Priority Data
Feb. 3, 2010 (TW) 099103099

(51) Int. Cl. F16B 37/00; B21K 1/64

(52) U.S. Cl. 411/427; 470/26

(57) ABSTRACT

A magnesium nut manufacturing method includes the steps of: providing a magnesium wire or rod; processing a directly-heating procedure, a thermal insulation material coating and directly-heating procedure or a directly-heating and thermal insulation material coating procedure on the magnesium wire or rod; forming a nut blank and a through hole thereof from the magnesium wire or rod, with the through hole having an inner thread to produce a magnesium nut member.

### CROSS REFERENCE TO RELATED APPLICATIONS

This application is a continuation-in-part of U.S. patent application Ser. No. 12/783,703, filed May 20, 2010, which is hereby incorporated by reference in its entirety.

### BACKGROUND OF THE INVENTION

1. Field of the Invention

The present invention relates to a magnesium nut manufacturing method and a magnesium nut member produced thereby. More particularly, the present invention relates to a magnesium nut manufacturing method for a magnesium wire or rod in a directly-heating treatment to produce a magnesium nut member.

2. Description of the Related Art

U.S. Pat. Appl. Pub. No. 20060130947, entitled “Magnesium-based alloy screw and method of manufacturing the same,” discloses a magnesium-based alloy screw manufacturing method, including the steps of: head-forging step and thread-rolling step. In the head-forging step a holding die is used to mount a magnesium alloy wire and a screw head is formed on the magnesium alloy wire by a punch member.

In the thread-rolling step both of the holding die and the punch member are heated in a predetermined temperature, ranging between 140 and 250 degrees Celsius. Accordingly, both of the heated holding die and the heated punch member further heat the magnesium alloy wire to the predetermined temperature such that the magnesium alloy wire is processed in indirectly-heating treatment.

However, the above-mentioned method requires preheating the holding die and the punch member in a predetermined temperature prior to processing the forging the screw head. After heated, the holding die and the punch member can be used to forge the magnesium alloy wire that results in sophistications in process. In addition, the holding die and the punch member must be repeatedly heated in maintaining the temperature (i.e. operation temperature) that may also result in energy waste and an increase of manufacturing cost.

Briefly, the manufacturing method described in No. 20060130947 is unsuitable for mass production. Hence, there is a need of providing a screw manufacturing method to improve the above problems of the complicated process, waste energy and increasing manufacture cost. In other words, there is a need of providing an improved screw manufacturing method suitable for mass production.

By way of examples, the conventional manufacturing method is suitable for ordinary materials (unsuitable for magnesium) for producing conventional nut members, including brass nuts, aluminum nuts, alloy nuts, stainless steel nuts, stainless steel flange nuts, stainless steel flange nylon insert lock nuts, stainless steel hex nuts, stainless steel heavy hex nuts, corten steel heavy hex nuts, nylon insert lock nuts, stainless steel nylon insert lock nuts, zinc die casting nuts, din and domed cap nuts, and flange nylon insert lock nuts.

As is described in greater detail below, the present invention provides a magnesium nut manufacturing method and a magnesium nut member produced thereby. A magnesium wire or rod is processed in a directly-heating process, a thermal insulation material coating and directly-heating procedure or a directly-heating and thermal insulation material coating procedure to produce the magnesium nut member in such a way as to mitigate and overcome the above problem.

### SUMMARY OF THE INVENTION

The primary objective of this invention is to provide a magnesium nut manufacturing method and a magnesium nut member produced thereby. A magnesium wire or rod is processed in a directly-heating procedure, a thermal insulation material coating and directly-heating procedure or a directly-heating and thermal insulation material coating procedure to produce the magnesium nut member. Accordingly, the magnesium nut manufacturing method is successful in simplifying the entire process.

The magnesium nut manufacturing method in accordance with an aspect of the present invention includes the steps of:

providing a magnesium wire or rod with a predetermined diameter;

directly heating the magnesium wire or rod in a predetermined temperature; and

forming a nut blank and a through hole thereof from the magnesium wire or rod, with the through hole having an inner thread.

As is described above, a magnesium nut member comprises a nut body and a through hole thereof formed from a magnesium wire or rod with a predetermined diameter in a directly heating procedure, wherein the through hole has an inner thread.

The magnesium nut manufacturing method in accordance with a separate aspect of the present invention includes the steps of:

providing a magnesium wire or rod with a predetermined diameter;

thermal insulation material coating and directly heating the magnesium wire or rod, or directly heating and thermal insulation material coating the magnesium wire or rod; and

forming a nut blank and a through hole thereof from the magnesium wire or rod, with the through hole having an inner thread.

As is described above, a magnesium nut member comprises a nut body and a through hole thereof formed from a magnesium wire or rod with a predetermined diameter in a thermal insulation material coating and directly-heating procedure or a directly-heating and thermal insulation material coating procedure, wherein the through hole has an inner thread.

In yet a further separate aspect of the present invention, the magnesium wire or rod is made from a magnesium alloy material.

In yet a further separate aspect of the present invention, the predetermined temperature ranges between 100° C. and 300° C.

In yet a further separate aspect of the present invention, the thermal insulation material is selected from an inorganic material or an organic material.

In yet a further separate aspect of the present invention, the inorganic material is selected from graphite or boron nitride (BN).

In yet a further separate aspect of the present invention, the nut blank is formed in a forging procedure.

In yet a further separate aspect of the present invention, the inner thread is formed in the nut blank by a thread-forming procedure.

Further scope of the applicability of the present invention will become apparent from the detailed description given hereinafter. However, it should be understood that the detailed description and specific examples, while indicating preferred embodiments of the invention, are given by way of illustration only, since various modifications will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart of a magnesium nut manufacturing method in accordance with a first preferred embodiment of the present invention.

FIG. 2 is a flow chart of a magnesium nut manufacturing method in accordance with a second preferred embodiment of the present invention.

FIG. 3 is a flow chart of a magnesium nut manufacturing method in accordance with a third preferred embodiment of the present invention.

FIG. 4 is a top view of a magnesium nut blank in accordance with a preferred embodiment of the present invention.

FIG. 5 is a top view of a magnesium nut member in accordance with a preferred embodiment of the present invention.

FIG. 6 is a partially-cutaway sectional view of the magnesium nut member in accordance with a preferred embodiment of the present invention, shown in FIG. 5.

### DETAILED DESCRIPTION OF THE INVENTION

It is noted that a magnesium nut manufacturing method in accordance with the preferred embodiment of the present invention is suitable for producing various nuts, for example, including square nuts, hex nuts, heavy hex nuts, hex cap nuts, hex serrated nuts, hex flange nuts, hex slotted nuts, hex jam nuts, round nuts, domed cap nuts, U nuts, T nuts, anchor nuts, wheel nuts, wing nuts, eye nuts, kep nuts, clinch nuts, hex coupling nuts (or high nuts), pipe nuts, spring nuts, heavy duty wheel hub nuts, acorn cap nuts, all-metal prevailing torque type nuts, closed end acorn nuts, conical washer nuts, flat washer nuts, self-locking nuts, sliding nuts, self-locking nut (SLN), weld nuts, height strength nuts, structural nuts, hex machine screw nuts, big size nuts or other special nuts which are not limitative of the present invention.

A magnesium nut member produced by the magnesium nut manufacturing method in accordance with the preferred embodiment of the present invention is made from magnesium or magnesium alloys which have a perfect degree of physical and chemical characteristics of magnesium metal. It will be understood that the magnesium nut member may not be made from other ordinary metals, including stainless steel, low-carbon steel (mild steel), medium carbon steel, alloy steel and bronze, for example.

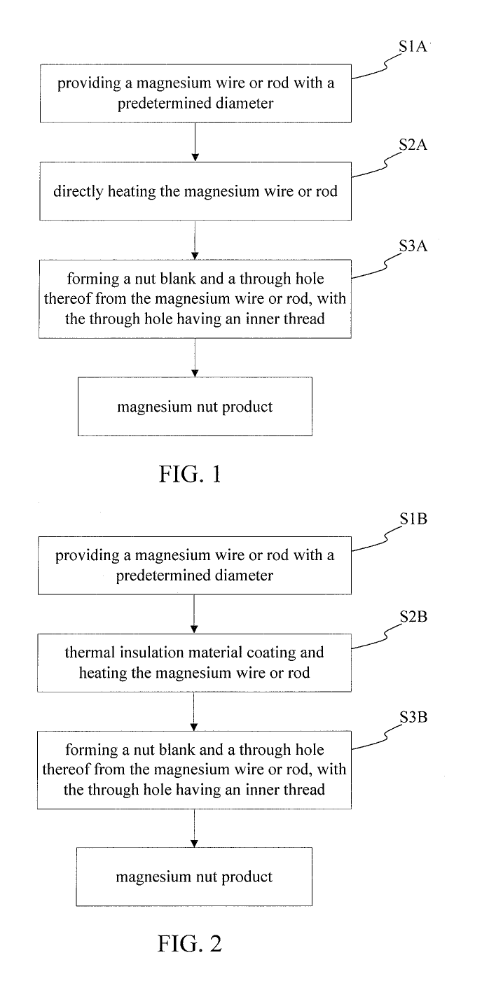

FIG. 1 shows a flow chart of a magnesium nut manufacturing method in accordance with a first preferred embodiment of the present invention. With continued reference to FIG. 1, the magnesium nut manufacturing method includes the step S1A of: providing a magnesium wire or rod with a predetermined diameter. The predetermined diameter of the magnesium wire or rod is preformed and suitable for forming a magnesium nut member.

Still referring to FIG. 1, the magnesium nut manufacturing method includes the step S2A of: directly heating the magnesium wire or rod to a predetermined temperature in a heater. The predetermined temperature ranges between 100° C. and 300° C. which is not limitative of the present invention.

FIG. 4 shows a top view of a magnesium nut blank in accordance with a preferred embodiment of the present invention; FIG. 5 shows a top view of a magnesium nut member in accordance with a preferred embodiment of the present invention; FIG. 6 is a partially-cutaway sectional view of the magnesium nut member in accordance with a preferred embodiment of the present invention, as best shown in FIG. 5.

Referring again to FIGS. 1 and 4, the magnesium nut manufacturing method includes the step S3A of: forming a nut blank 1 and a through hole thereof from the magnesium wire or rod by a nut forming machine in the predetermined temperature. In the preferred embodiment, one-step or multi-step forging is applied to the magnesium wire or rod to form the magnesium nut blank with a predetermined outer circumference (i.e. hexagon nut shape, as best shown in FIG. 4). The through hole is formed at a center portion of the nut blank in an extrusion procedure, with using an extrusion machine.

With continued reference to FIGS. 1, 4 and 5, in step S3A, an inner thread 11, as best shown in FIG. 5, is further formed on an inner circumferential surface of the through hole by a thread-tapping machine or the like to produce a magnesium nut product 10 such that the magnesium nut member will be completely manufactured.

By way of example, the inner circumferential surface of the through hole may be formed with a single thread, a double thread, a high-low thread or a tri-lobular thread which is not limitative of the present invention. Referring again to FIG. 5, the magnesium nut product 10 is processed in a surface treatment to produce the magnesium nut member.

Turning now to FIG. 2, a flow chart of a magnesium nut manufacturing method in accordance with a second preferred embodiment of the present invention is shown. Steps S1B and S3B of the second embodiment are identical with steps S1A and S3A of the first embodiment and the detail description of steps S1B and S3B are omitted.

Referring to FIG. 2, the magnesium nut manufacturing method of the second preferred embodiment includes the step S3B of: coating a thermal insulation material on at least one predetermined section (i.e. outer circumferential surface) of the magnesium wire or rod in a thermal isolating procedure, and subsequently heating the magnesium wire or rod to the predetermined temperature in a heater. It will be understood that a thermal isolating and directly heating treatment is applied to the magnesium wire or rod. In step S2B, prior to heating operation, the predetermined section of the magnesium wire or rod is coated by a thermal insulation material so as to avoid thermal energy loss from the magnesium wire or rod to the ambient environment. By way of example, the coating technology may be roller coating or spray coating which is not limitative of the present invention.

In step S3B, after heating operation, the predetermined section of the heated magnesium wire or rod coated by the thermal insulation material is processed to form the magnesium nut member in the predetermined temperature without the need of further heating operation.

In the second preferred embodiment, the thermal insulation material may be selected from an inorganic material or an organic material. The inorganic material of the thermal insulation material may be selected from graphite or boron nitride (BN).

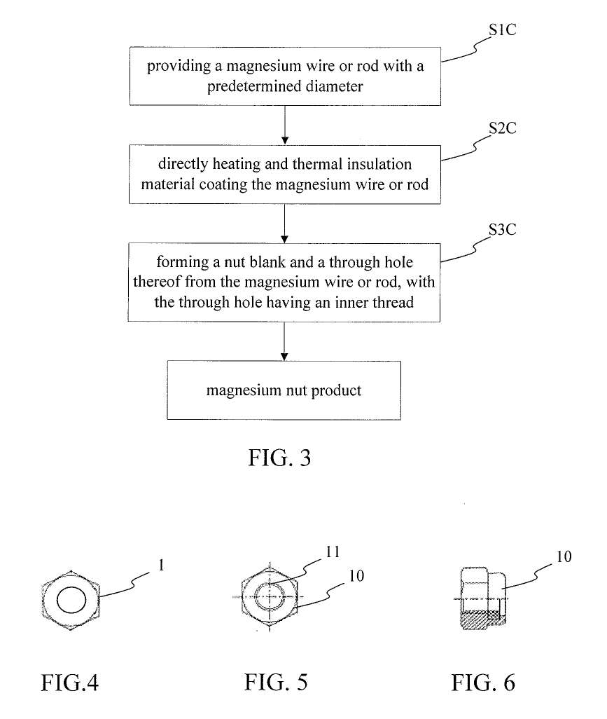

Turning now to FIG. 3, a flow chart of a magnesium nut manufacturing method in accordance with a third preferred embodiment of the present invention is shown. Steps S1C and S3C of the third embodiment are identical with steps S1A and S3A of the first embodiment and the detail description of steps S1C and S3C are omitted.

Still referring to FIG. 3, the magnesium nut manufacturing method of the third preferred embodiment includes the step S2B of: heating the magnesium wire or rod to the predetermined temperature, and subsequently coating the thermal insulation material on the predetermined section (i.e. outer circumferential surface) of the magnesium wire or rod in a thermal isolating procedure. In step S3C, after heating operation, the predetermined section of the heated magnesium wire or rod coated by the thermal insulation material is processed to form the magnesium nut member in the predetermined temperature.

Although the invention has been described in detail with reference to its presently preferred embodiment(s), it will be understood by one of ordinary skill in the art that various modifications can be made without departing from the spirit and the scope of the invention, as set forth in the appended claims.

What is claimed is:

1. A magnesium nut manufacturing method, comprising the steps of:
providing a magnesium wire or rod with a predetermined diameter;
directly heating the magnesium wire or rod in a predetermined temperature; and
forming a nut blank and a through hole thereof from the magnesium wire or rod, with the through hole having an inner thread.

2. The magnesium nut manufacturing method as defined in claim 1, wherein the predetermined temperature ranges between ranges between 100° C. and 300° C.

3. The magnesium nut manufacturing method as defined in claim 1, wherein the magnesium wire or rod is forged to form the nut blank, and the inner thread is formed in a thread-tapping procedure.

4. The magnesium nut manufacturing method as defined in claim 1, wherein the magnesium wire or rod is coated by a thermal insulation material prior to heating the magnesium wire or rod, or after heating the magnesium wire or rod.

5. The magnesium nut manufacturing method as defined in claim 4, wherein the thermal insulation material is coated on a predetermined section of the magnesium wire or rod.

6. The magnesium nut manufacturing method as defined in claim 4, wherein the thermal insulation material is selected from an inorganic material or an organic material.

7. A magnesium nut member comprising:
a nut body formed from a magnesium wire or rod directly heated in a predetermined temperature;
a through hole formed at a center portion of the nut body; and
an inner thread formed on an inner circumferential surface of the through hole.

8. The magnesium nut member as defined in claim 7, wherein the predetermined temperature ranges between ranges between 100° C. and 300° C.

9. The magnesium nut member as defined in claim 7, wherein the magnesium wire or rod is coated by a thermal insulation material prior to heating the magnesium wire or rod or after heating the magnesium wire or rod.

10. The magnesium nut member as defined in claim 9, wherein the thermal insulation material is coated on a predetermined section of the magnesium wire or rod.

11. The magnesium nut member as defined in claim 9, wherein the thermal insulation material is selected from an inorganic material or an organic material.
